(19) United States
(12) Patent Application Publication
(10) Pub. No.: US 2025/0247822 A1
(43) Pub. Date: Jul. 31, 2025

(54) TECHNOLOGIES FOR MOBILE-TERMINATED, SMALL-DATA TRANSMISSION

(71) Applicant: Apple Inc., Cupertino, CA (US)

(72) Inventors: Fangli Xu, Beijing (CN); Alexander Sirotkin, Tel Aviv (IL); Haijing Hu, Los Gatos, CA (US); Naveen Kumar R. Palle Venkata, San Diego, CA (US); Pavan Nuggehalli, San Carlos, CA (US); Ralf Rossbach, Munich (DE); Sethuraman Gurumoorthy, San Ramon, CA (US); Yuqin Chen, Beijing (CN); Zhibin Wu, Los Altos, CA (US)

(73) Assignee: Apple Inc., Cupertino, CA (US)

(21) Appl. No.: 18/856,040

(22) PCT Filed: Mar. 31, 2023
(86) PCT No.: PCT/US2023/017066

§ 371 Date: Oct. 10, 2024

Related U.S. Application Data
(60) Provisional application No. 63/331,250, filed on Apr. 14, 2022.

(51) Int. Cl. H04W 68/00; H04L 5/14; H04W 72/11; H04W 74/0833

(52) U.S. Cl. CPC H04W 68/005; H04L 5/14; H04W 72/11; H04W 74/0833

(57) ABSTRACT

The present application relates to devices and components including apparatuses, systems, and methods for technologies for mobile-terminated, small-data transmissions in wireless networks.

### CROSS REFERENCE TO RELATED APPLICATION

This application claims priority to U.S. Provisional Application No. 63/331,250, filed Apr. 14, 2022. The contents of this application is hereby incorporated by reference in its entirety for all purposes.

### BACKGROUND

Third Generation Partnership Project (3GPP) Technical Specifications (TSs) define standards for wireless networks. One area of study for developing these TSs is for managing small-data transmissions.

### BRIEF DESCRIPTION OF THE DRAWINGS

FIG. 1 illustrates a network environment in accordance with some embodiments.

FIG. 2 illustrates a mobile-terminated (MT)-small-data transmission (SDT) operation in accordance with some embodiments.

FIG. 3 illustrates a signaling diagram for a paging-triggered mobile-originated (MO)-SDT in accordance with some embodiments.

FIG. 4 illustrates another signaling diagram for a paging-triggered MO-SDT in accordance with some embodiments.

FIG. 5 illustrates another MT-SDT operation in accordance with some embodiments.

FIG. 6 illustrates an operational flow/algorithmic structure in accordance with some embodiments.

FIG. 7 illustrates an operational flow/algorithmic structure in accordance with some embodiments.

FIG. 8 illustrates an operational flow/algorithmic structure in accordance with some embodiments.

FIG. 9 illustrates an operational flow/algorithmic structure in accordance with some embodiments.

FIG. 10 illustrates a user equipment in accordance with some embodiments.

FIG. 11 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, or network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

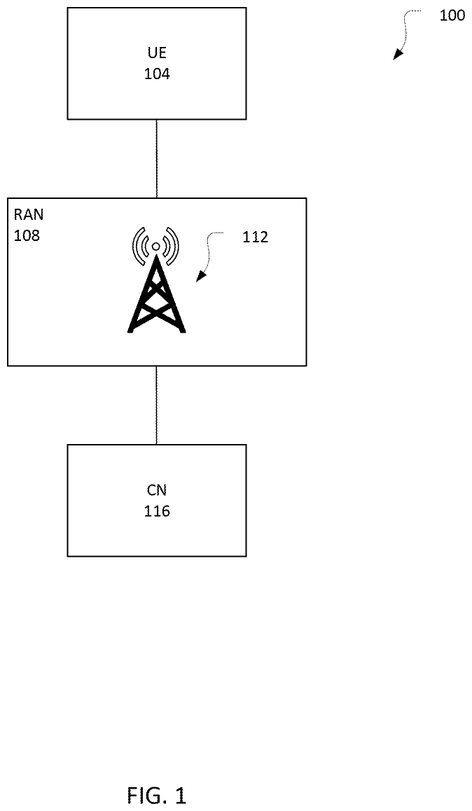

FIG. 1 illustrates a network environment 100 in accordance with some embodiments. The network environment 100 may include a UE 104 coupled with a radio access network (RAN) 108 that includes base station (BS) 112. The UE 104 and the BS 112 may communicate over air interfaces compatible with 3GPP TSs such as those that define Fifth Generation System (5GS) (or later) standards. The BS 112 may be a next generation node B (gNB) to provide one or more New Radio (NR) cells that present NR user plane and control plane protocol terminations toward the UE 104.

The RAN 108 may be coupled with a core network (CN) 116. The CN 116 may have a variety of network functions that provide services such as storing subscription information, authenticating UEs/network components, registering and tracking UEs, managing quality of service (QOS) aspects, controlling data sessions, and forwarding uplink/downlink traffic.

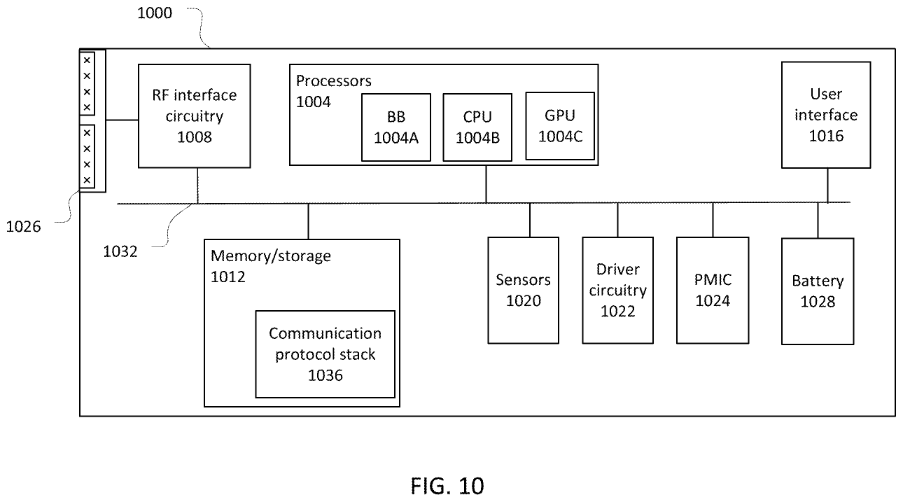

The UE 102 may include a radio resource control (RRC) state machine that perform operations related to a variety of RRC procedures including, for example, paging, RRC connection establishment, RRC connection reconfiguration, and RRC connection release. The RRC state machine may be implemented by protocol processing circuitry, see, for example, baseband circuitry 1004A of FIG. 10.

The RRC state machine may transition the UE 104 into one of a number of RRC states (or “modes”) including, for example, a connected state (RRC connected), an inactive state (RRC inactive), and an idle state (RRC idle). A UE may start in RRC idle when it first camps on an NR cell, which may be after the UE 104 is switched on or after an inter-system cell reselection from a Long Term Evolution (LTE) cell. To engage in active communications, the RRC state machine may transition the UE from RRC idle to RRC connected by performing an RRC setup procedure to establish a logical connection, for example, an RRC connection, with the base station 108. In RRC connected, the UE may be configured with at least one signaling radio bearer (SRB) for signaling (for example, control messages) with the base station; and one or more data radio bearers (DRBs) for data transmission. When the UE is less actively engaged in network communications, the RRC state machine may transition the UE from RRC connected to RRC inactive using an RRC release procedure. The RRC inactive state may allow the UE 104 to reduce power consumption as compared to RRC connected, but will still allow the UE 104 to quickly transition back to RRC connected to transfer application data or signaling messages.

In Release 16 and prior networks (for example, networks that implemented 3GPP TS Releases prior to Release 17), for uplink data arrival for an inactive UE, the UE would trigger an RRC resume procedure and enter the connected state for data transmission. For downlink data arrival for the inactive UE in these networks, the network would send a RAN paging message to request the UE transition back to the connected state for data transmission.

Release 17 networks may utilize mobile-originated (MO)-small-data transmission (SDT) procedures that allow an inactive UE, upon receipt of uplink data arrival of SDT resource blocks (RBs), to perform UL data transmission in the inactive state. Data to be transmitted may be considered SDT if a volume of the data is less than a predetermined threshold. This may reduce signaling overhead and UE power consumption by avoiding the transition to connected state and reducing latency by allowing fast transmission of small, and likely infrequent, packets that include, for example, positioning data. When downlink data arrives at a Release 17 network for a UE in an inactive state, the network may trigger RAN paging to request the UE transition back to the connected state. If the UE is in the process of an SDT procedure, and non-SDT data radio bearer (DRB) downlink data arrives at the network, the network may directly send an RRC resume message during the SDT procedure and request the UE transition back to the connected state.

However, for the downlink data arrival case, even for the small and infrequent data transmission, the UE has to transition back to the connected state for data reception. Providing mobile terminated (MT)-SDT procedures based on downlink-triggered SDT RBs may provide similar benefits to MO-SDT procedures. MT-SDT procedures may allow a network to send DL data to a UE that is in an inactive state without requiring the UE to transition to the connected state.

Embodiments describe various aspects of MT-SDT operation. Embodiments include MT-SDT operation according to a first MT-SDT procedure and MT-SDT operation according to a second MT-SDT procedure. The first MT-SDT procedure may include an MO-SDT transmission, while the second MT-SDT may not.

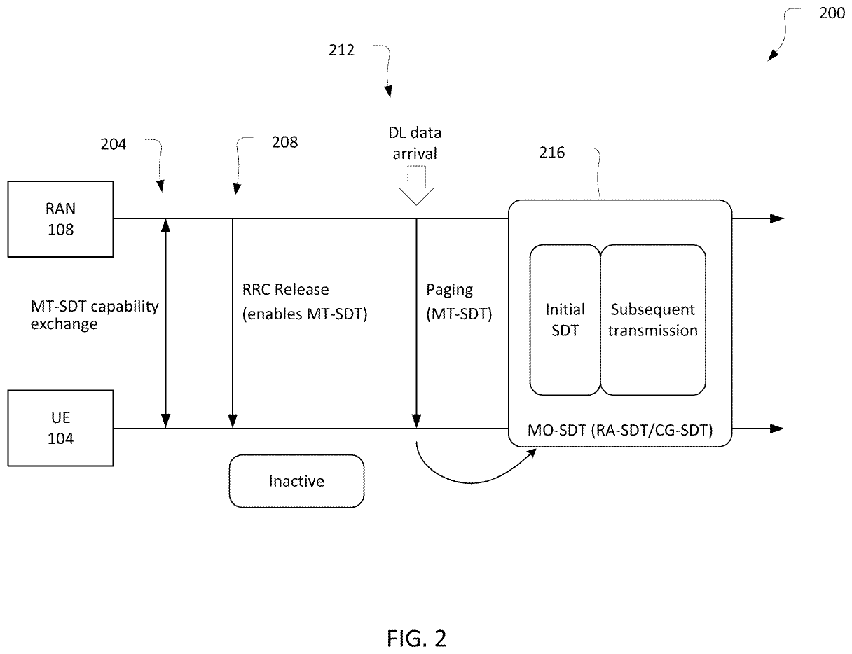

FIG. 2 illustrates an MT-SDT operation 200 of the first MT-SDT procedure in accordance with some embodiments.

The MT-SDT operation 200 may include, at 204, the RAN 108 and the UE 104 performing an MT-SDT capability exchange. The MT-SDT capability exchange may indicate that both the UE 104 and the RAN 108 supports the MT-SDT feature.

The MT-SDT capability exchange may include the UE 104 transmitting a UE MT-SDT capability to the RAN 108. The UE MT-SDT capability, which may be part of an access stratum (AS) capability information element (IE), may indicate an MT-SDT paging reception capability that informs the RAN 108 of whether the UE 104 is capable of receiving a paging message to indicate an arrival of downlink data that is to be transmitted to the UE 104 as an MT-SDT transmission. The UE MT-SDT capability may further indicate whether the UE 104 supports the first MT-SDT procedure or the second MT-SDT procedure.

In some embodiments, the UE MT-SDT capability may additionally/alternatively include an SDT-DL-semi-persistent scheduling (SPS) capability. The SDT-DL-SPS capability may indicate whether the UE 104 supports DL-SPS in the MT-SDT. In some embodiments, the SDT-DL-SPS capability may indicate support of one activated SPS process in MT-SDT. In other embodiments, the UE MT-SDT capability may include a multi-SPS capability to indicate whether the UE 104 supports a plurality of activated SPS processes in MT-SDT. In some embodiments, the (multi-) SPS capability may be mandatory for MT-SDT, but optional for MO-SDT.

In some embodiments, the capabilities may be designed per UE, frequency band, frequency range (FR) (for example, FR1 or FR2), or duplexing scheme (for example, time division duplexing (TDD) or frequency division duplexing (FDD).

If both the UE 104 and the RAN 108 support the MT-SDT feature, the MT-SDT operation 200 may proceed to the RAN 108 enabling MT-SDT by transmitting an RRC message, for example, RRC release message with suspend configuration, at 208. The RRC release message may include an MT-SDT configuration and, potentially, an MO-SDT configuration. Upon receiving the RRC release message, the UE 104 may transition to an RRC inactive state.

At 212, DL data may arrive at the RAN 108. The RAN 108 may send the UE 108 a paging message to indicate that the DL data is to be sent as SDT RBs via an MT-SDT transmission.

The paging message may serve as an MO-SDT trigger condition. For example, upon receipt of the paging message at 212, the UE 104 may initiate an MO-SDT session 216.

The MO-SDT session may begin with the UE 104 transmitting an initial MO-SDT message to the RAN 108. In some embodiments, the initial MO-SDT message may be a random access (RA)-SDT. The RA-SDT message may be a random access channel (RACH) transmission sent to the RAN 108. The RAN 108 may then utilize dynamic scheduling for the remainder of the MO-SDT session 216, to schedule subsequent transmissions including, for example, the MT-SDT transmission that includes the DL data.

In some embodiments, the MO-SDT message may be a configured grant (CG)-SDT message. The RAN 108 may configure the CG resources in an RRC message such as, for example, a dedicated RRC configuration message. The UE 104 may then use the CG resources to transmit the CG-SDT message within the MO-SDT session. Upon receiving the CG-SDT message, the RAN 108 may utilize dynamic scheduling for the remainder of the MO-SDT session 216 to schedule subsequent transmissions including, for example, the MT-SDT transmission that includes the DL data.

In various embodiments, the subsequent transmissions may include both UL and DL SDT transmissions and acknowledgment/feedback regarding same. The RAN 108 may schedule UE-specific UL/DL data transmission via a UE-specific cell-radio network temporary identity (C-RNTI), and the data transmission may be sent via an initial BWP of the current serving cell. In some embodiments, the RAN 108 may configure DL-SPS resources for DL transmissions during the MO-SDT session. This may include both the initial DL transmission and subsequent DL transmissions. The DL-SPS resources may be configured by an RRC message such as, for example, a dedicated RRC configuration message.

Unless otherwise described herein, operation of the UE 104 and RAN 108 within the MO-SDT session may be similar to that described in Change Requests (CRs) for Release 17 TSs as defined in R2-2204234—Introduction of SDT, 3GPP TSG-RAN WG2 Meeting #117 Electronic Elbonia, 21 Feb.-3 Mar. 2022; R2-2204216—Introduction of Small Data Transmission for MAC spec, 3GPP TSG-RAN2 Meeting #117e Electronic, 21 Feb.-3 Mar. 2022; and R2-2203768—Introduction of SDT, 3GPP TSG-RAN WG2 Meeting #117-e Electronic, 21 Feb.-3 Mar. 2022.

In some embodiments, the UE 104 may utilize the initial SDT transmission to provide the RAN 108 an indication of whether the UE 104 has UL SDT data to transmit within the MO-SDT session 216. For example, if the UE 104 has UL SDT data to transmit, the UE 104 may perform an MO-SDT procedure. This may include transmitting a special RACH message that includes a larger transport block size (TBS) as compared to a legacy, for example, non-MO-SDT, RACH message. An SDT-specific RACH may be differentiated from a legacy RACH based on the configuration. While the configuration parameters may be the same, the value or the RACH TDM/FDM resource may be different. The RAN 108 may differentiate an SDT-specific RACH from a legacy RACH based on these differences. Upon receiving the special RACH message, the RAN 108 may dynamically schedule UL resources for the UE 104 to transmit the MO-SDT transmission.

If, on the other hand, the UE 104 does not have UL SDT data to transmit, and the initial SDT transmission is purely triggered by MT paging, the UE 104 may perform either of the following two options. In a first option, the UE 104 may use a legacy RACH resource for the initial SDT transmission. In this instance, the initial transmission may include an RRC resume request that includes an inactive radio network temporary identity (I-RNTI). The RRC resume request may not be used to resume an RRC connection, instead, it may be used for SDT initiation and to carry information (for example, message authentication code-integrity (MAC-I), UE ID) that allows the RAN 108 to identify the SDT UE 104. The RAN 108, upon receiving the initial SDT transmission with the legacy RACH resource and the I-RNTI, may understand the access is based solely on the MT-SDT transmission.

In a second option, the UE 104 may set a resume cause within the RRC resume request in a manner to indicate that the initial SDT transmission is purely triggered by MT paging.

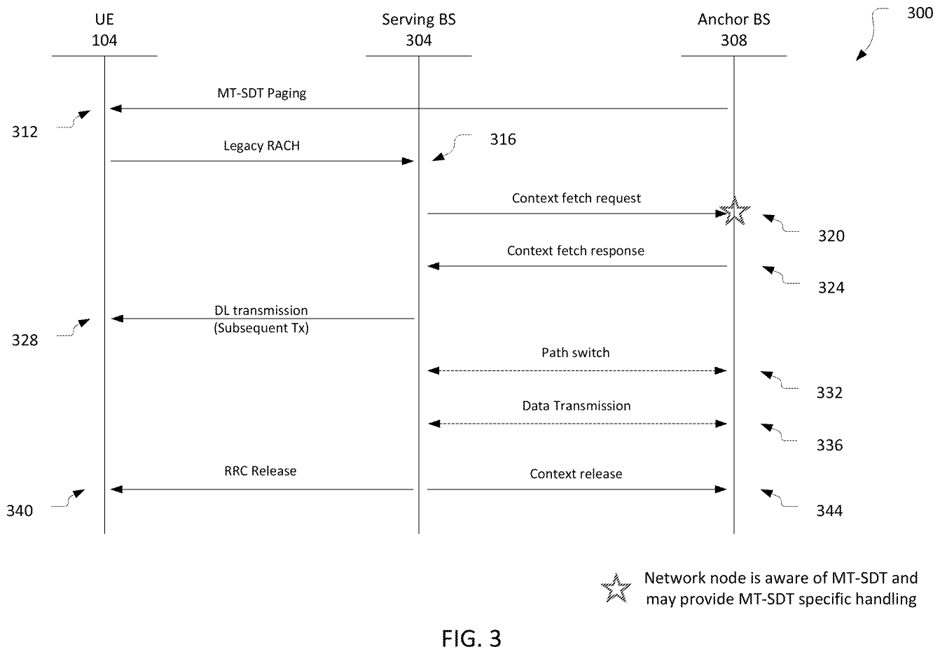

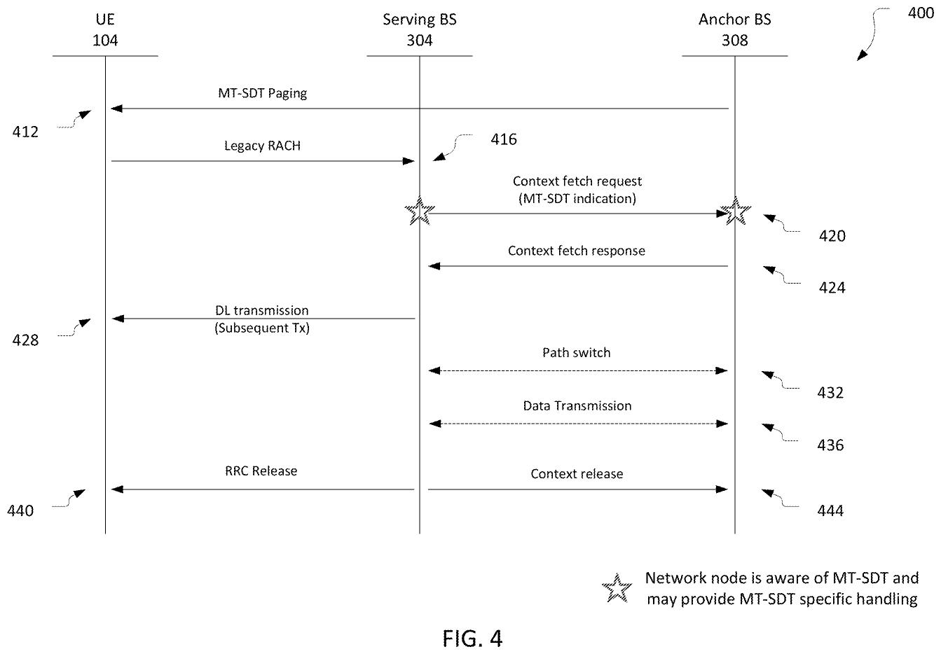

FIGS. 3 and 4 respectively illustrate signaling diagrams 300 and 400 for a paging-triggered MO-SDT session in accordance with some embodiments. The paging-triggered MO-SDT session may be similar to MO-SDT session 216 described above with respect to the MT-SDT operation 200. The signaling diagrams 300 and 400 illustrate signals between the UE 104, a serving BS 304 of the RAN 108, and an anchor BS 308 of the RAN 108 in accordance with two options.

The signaling diagram 300, representing the first option, may include, at 312, the UE 104 receiving an MT-SDT paging message from the anchor BS 308. The paging message may be similar to the paging message at 212 described above with respect to the MT-SDT operation 200.

At 316, the UE 104 may transmit a legacy RACH message to the serving BS 304. Upon receiving the legacy RACH message, the serving BS 304 may forward a context fetch request to the anchor BS 308 at 320 to obtain a UE context stored at the anchor BS 308. The context fetch request may prompt the anchor BS 308 to determine whether to trigger a context relocation and data forwarding procedure as part of the MT-SDT process. In this embodiment, the anchor BS 308 may be aware of the MT-SDT procedure, but the serving BS 304 may not.

If the anchor BS 308 is able to identify the UE 104 using a UE context ID, successfully verifies the UE 104 based on integrity protection within the context fetch request, and decides to provide the UE context to the serving BS 304, it may transmit a context fetch response to the serving BS 304 at 324. The anchor BS may forward the DL SDT data to the serving BS 304 over the Xn interface and the serving BS 304 may then use the UE context to transmit the DL SDT data to the UE 104 in the DL transmission at 328. The DL transmission may be part of the subsequent transmission of the MO-SDT session 216 described above with respect to FIG. 2.

In some instances, the anchor BS 308 and the serving BS may perform a partial UE context relocation. In this instances, the anchor BS 308 may send a partial UE context transfer message to the serving BS 304. If the serving BS can perform the DL SDT transmission without anchor relocation, it will send an acknowledgement message to the anchor BS 308. The anchor BS 308 may forward the DL SDT data to the serving BS 304 via the Xn interface. The serving BS 304 may then schedule the data for transmission to the UE 104 over the Uu interface.

In some embodiments, the anchor BS 308 may provide an explicit indication in a message (for example, the context fetch response) to the serving BS 304 that the procedure is associated with an MT-SDT procedure. At 332 and 336, the anchor BS 308 and the serving BS 304 may respectively perform a path switch and data transmission.

The serving BS 304 may transmit an RRC release message to the UE 104 at 340 and may further transmit a context release to the anchor BS 308. The RRC release message may provide the UE 104 with an indication of an end of the MO-SDT session. In other embodiments, other RRC messages (for example, an RRC resume message or an RRC last message) may be used to mark the end of the MO-SDT session. In still other embodiments, the SDT session may be closed by other processes, for example, by expiration of a timer started at the start of the session or upon receipt of the MT-SDT paging message at 312.

In general, the full/partial context fetch procedure and patch switch procedure may be similar to legacy procedures such as those described in, for example, 3GPP TS 38.423 v17.0.0 (2022 Apr. 6).

The signaling diagram 400, which may represent the second option, may include signals that are similar to like-named signals present in signaling diagram 300. However, in the second option, both the serving BS 304 and the anchor BS 308 are aware of the UE access for MT-SDT. The serving BS 304 may determine whether to provide the MT-SDT or not. This may be based on a current network situation, for example, whether the resources provided on the air interface (e.g., Uu interface) are sufficient to accommodate the MT-SDT transmission, or whether the number of transmissions within a current MO-SDT session has exceeded a predetermined threshold. The serving BS 304 may then generate an MT-SDT indication, which may be transmitted with the context fetch request at 420, to inform the anchor BS 308 of whether the MT-SDT procedure is to proceed. For example, if the serving BS 304 determines the MT-SDT procedure is not to proceed, the MT-SDT indication may be set to ‘false’ and the MT-SDT procedure, triggered by the anchor BS 308 sending the MT-SDT paging message at 412, may be terminated. If the SDT procedure is to proceed, the MT-SDT indication may be set to ‘true’ and the MT-SDT procedure may proceed.

The anchor BS 408 may then determine whether to trigger context relocation and data forwarding procedure as part of the MT-SDT process consistent with the MT-SDT indication.

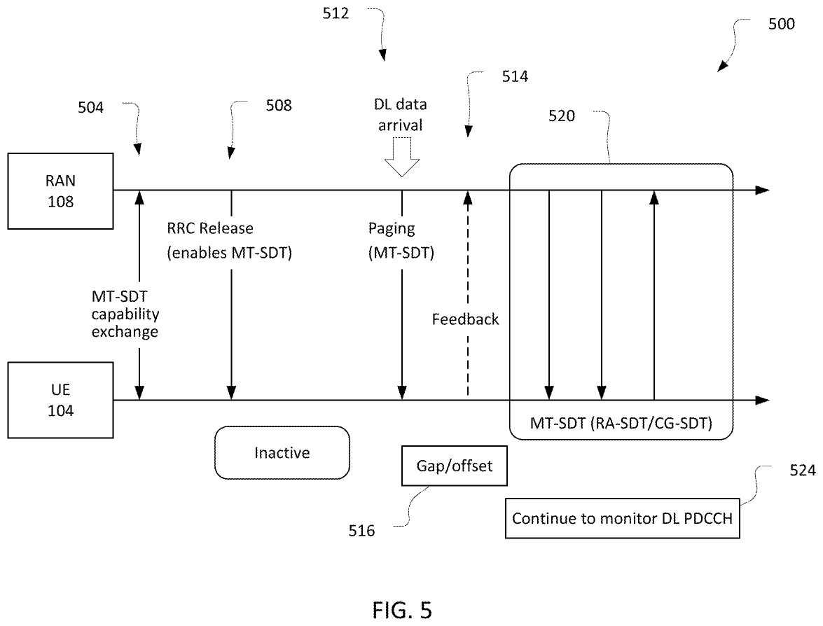

FIG. 5 illustrates an MT-SDT operation 500 of the second MT-SDT procedure in accordance with some embodiments.

The MT-SDT operation 500 may include, at 504, the RAN 108 and the UE 104 performing an MT-SDT capability exchange. The MT-SDT capability exchange may be similar to that described above with respect to MT-SDT operation 200.

If both the UE 104 and the RAN 108 support the MT-SDT feature, the MT-SDT operation 500 may proceed to the RAN 108 enabling MT-SDT by transmitting an RRC release message at 508. Enabling MT-SDT with the RRC message may be similar to that described above with respect to MT-SDT operation 200.

At 512, DL data may arrive at the RAN 108. The RAN 108 may send the UE 108 a paging message to indicate that DL data is to be sent via an MT-SDT transmission. Transmission of the paging message may be similar to that described above with respect to MT-SDT operation 200.

In MT-SDT operation 500, the UE 104 may start the DL data reception directly without first sending an MO-SDT transmission. In particular, the UE 104 may wait for a period of time, for example, gap/offset 516, after receipt of the paging message before monitoring a UE-dedicated physical downlink control channel (PDCCH) for DL transmissions at 524. The length of the gap/offset 516 may be predefined by a 3GPP TS or preconfigured. The RAN 108 may send scheduling information in the PDCCH to schedule DL resources for a subsequent MT-SDT transmission within MT-SDT session 520. The UE 104 may continue to monitor DL PDCCH throughout the MT-SDT session 520. The length of the MT-SDT session 520 and, therefore, the period in which the DL PDCCH may be monitored, may be controlled by an SDT timer.

The SDT timer may be a static timer that is started when the UE 104 starts the SDT PDCCH monitoring. Upon expiration of the static SDT timer, the UE 104 may terminate the MT-SDT procedure. In other embodiments, the SDT timer may be a dynamic timer that is extended for a period of time based on, for example, receipt of downlink transmissions.

In some embodiments, the RAN 108 may additionally/alternatively transmit a specific signal to terminate the MT-SDT procedure.

The UE 104 may use a C-RNTI to perform the UE-specific PDCCH monitoring. The C-RNTI may be preconfigured in the RRC release message transmitted at 508. In some embodiments, the C-RNTI may correspond to the I-RNTI.

In various embodiments, the UE-dedicated configuration for SDT UE dedicated transmissions discussed above for UL/DL data transmissions in subsequent transmissions of the MO-SDT session 216 may be re-used in the MT-SDT session 520.

In some embodiments, the RAN 108 may use preconfigured DL SPS resources for the DL transmissions during the MT-SDT session 520.

As compared to MT-SDT operation 300, MT-SDT operation 500 may better support one short DL transmission; however, the RAN 108 may not be aware of whether the UE 104 receives the paging successfully before performing any DL scheduling. Thus, in some embodiments, the UE 104 may transmit a feedback message at 514.

The feedback to the paging message may be performed in accordance with one of the following two options. In a first option, the feedback may be delivered via a UE-specific physical uplink control channel (PUCCH) or sounding reference signal (SRS). This option may be desirable if the UE 104 has a valid uplink timing advance (TA). If the UE 104 does not have a valid uplink TA, it may trigger a RACH prior to transmitting the feedback. The PUCCH/SRS resources for feedback may be configured in the RRC release transmitted at 508. The configuration of the PUCCH/SRS may associate the feedback transmissions with different DL beams. The UE 104 may select a suitable DL beam and then use the associated PUCCH/SRS resource for the feedback transmission.

In a second option, the feedback may be delivered via a PUSCH resource. The UE 104 may deliver a media access control (MAC) control element (CE) as feedback to the RAN 108 via a special PUSCH resource. The special PUSCH resource may be preconfigured and associated with a particular paging occasion or may be a CG-SDT resource. The RAN 108 may configure different resources associated with different DL beams. The UE 104 may identify one of the DL beams and use the associated uplink resources for the PUSCH.

In the event the UE 104 has uplink SDT data, it may deliver the data after providing the feedback message at 514. If the UE 104 has the uplink SDT data before transmitting the feedback message, the UE 104 may trigger the MO-SDT directly, obviating the need to deliver the paging message. If the RAN 108 receives an MO-SDT transmission in response to the paging message at 512, the operation may be similar to that described with respect to FIG. 2.

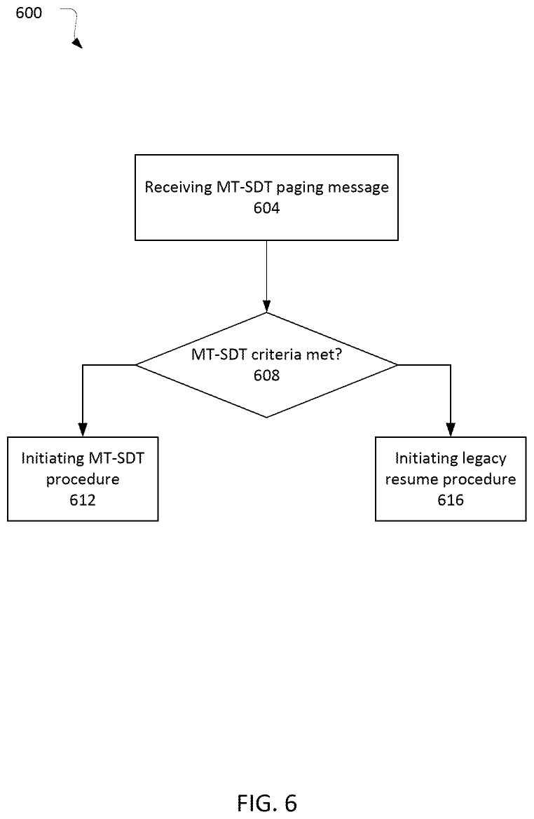

FIG. 6 illustrates an operation flow/algorithmic structure 600 in accordance with some embodiments. The operation flow/algorithmic structure 600 may be performed by a UE such as, for example, UE 104 or 800, or components thereof, for example, processing circuitry 804.

The operation flow/algorithmic structure 600 may include, at 604, receiving an MT-SDT paging message. The paging message may be similar to that described above with respect to FIG. 2.

The operation flow/algorithmic structure 600 may further include, at 608, determining whether MT-SDT criteria is met. The MT-SDT criteria may be based on a signal metric such as, for example, a reference signal receive power (RSRP) of the MT-SDT paging message. If the RSRP is greater than a predetermined RSRP threshold, the MT-SDT criteria may be considered to be met and the operation flow/algorithmic structure 600 may advance to initiating an MT-SDT procedure at 612. The MT-SDT procedure may be similar to the MT-SDT procedures described elsewhere herein. If the RSRP is not greater than the predetermined RSRP threshold, the MT-SDT criteria may be considered not to be met and the operation flow/algorithmic structure 600 may advance to initiating a legacy resume procedure at 616. The legacy resume procedure may include the UE transmitting an RRC resume message to the network to request that the UE transition to the RRC connected state.

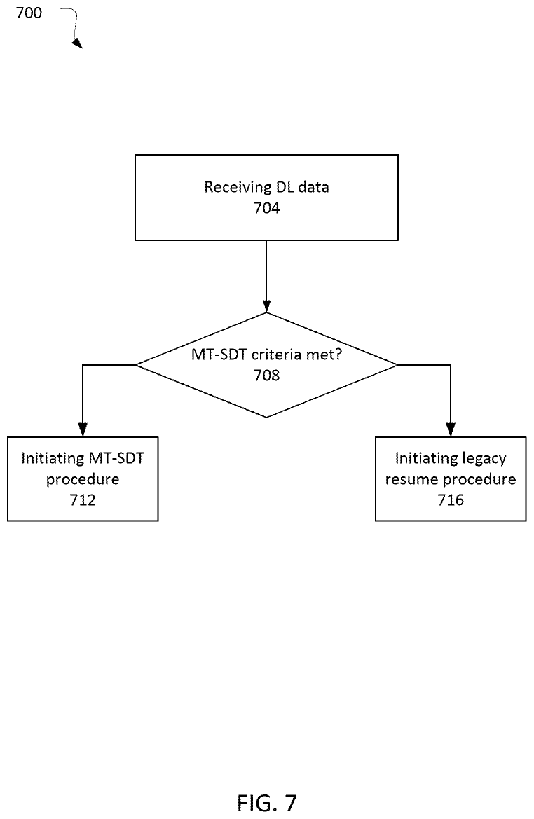

FIG. 7 illustrates an operation flow/algorithmic structure 700 in accordance with some embodiments. The operation flow/algorithmic structure 700 may be performed by a base station such as, for example, BS 112, anchor BS 308, or network device 900, or components thereof, for example, processing circuitry 904.

The operation flow/algorithmic structure 700 may include, at 704, receiving downlink data that is to be sent to a UE.

The operation flow/algorithmic structure 700 may further include, at 708, determining whether MT-SDT criteria is met. The MT-SDT criteria may be based on characteristics of the downlink data to be sent to the UE. For example, the downlink data may include SDT RBs for the UE and the MT-SDT criteria may be based on the type or amount of SDT-RBs. The base station may determine that the MT-SDT criteria is not met if, for example, the downlink traffic would be better served by transitioning the UE to the RRC connected state given the type/amount of SDT-RBs. In the event the MT-SDT criteria is not met, the operation flow/algorithmic structure 700 may advance to initiating a legacy resume procedure at 716. The legacy resume procedure may include the UE transmitting an RRC resume message to the network to request that the UE transition to the RRC connected state.

The base station may determine that the MT-SDT criteria is met if, for example, the downlink traffic would be better served by transmitting the data to the UE in the RRC inactive state given the type/amount of SDT-RBs. In the event the MT-SDT criteria is met, the operation flow/algorithmic structure 700 may advance to initiating the MT-SDT procedure at 712. The MT-SDT procedure may be similar to the MT-SDT procedures described elsewhere herein.

The MT-SDT criteria used at 608 or 708 may be predefined in 3GPP TSs or based on network or UE implementation.

As briefly described above, some embodiments may rely on DL-SPS transmissions to deliver SDT RBs. In Release 17, CG-SDT is only supported within one cell. It is not available for instances in which a cell changes. Further, CG-SDT requires a valid TA to be maintained in order to control the validity of the CG-SDT resource. Embodiments utilizing DL-SPS SDT operation during MT-SDT sessions, for example, MT-SDT session 520, may be accomplished as follows.

In the downlink, the DL-SPS SDT resource may be used for periodic DL data transmission in an MT-SDT session. Referring again to FIG. 5, the RAN 108 may provide configuration information in the RRC release message transmitted at 508 (or another RRC message) to configure the DL SPS for SDT purposes. The DL SPS configuration for SDT purposes may support a plurality of SPS configurations. For example, different SPS configurations may be tailored for different beams or periodicities. The RAN 108 may thereafter activate one or more of the configured SPS configurations. In some embodiments, the RAN 108 may activate selected SPS configurations by including activation information in the paging message transmitted at 512.

After the UE 104 receives the MT-SDT paging message at 512, the UE 104 may begin monitoring the SPS occasions of the activated SPS configurations directly for data reception.

In the event the paging feedback is used, the RAN 108 may begin the downlink SDT data transmissions using the configured SPS resources after receiving the paging feedback at 514.

If no paging feedback is used, the RAN 108 may deliver the downlink SDT data using the first SPS occasion after the gap/offset 516. In some embodiments, the UE 104 may send feedback based on receipt of the SPS transmission. This may inform the RAN 108 that the UE 104 has entered the MT-SDT session 520. The RAN 108 may then continue with additional downlink SDT transmissions.

In some embodiments, uplink synchronization, for example, having a valid TA, may allow the UE 104 to deliver uplink feedback to the downlink SPS transmissions. In some instances, if the uplink TA is invalid, the downlink SPS resources may be released.

In some embodiments, validation of the TA may be based on a TA timer or RSRP change. For example, a TA may be considered valid for a predetermined period of time after receiving the valid TA or until the RSRP changes more than a predetermined threshold.

In some embodiments, the DL-SPS SDT operation may additionally/alternatively be used for the MO-SDT session 216. The RAN 108 may configure the DL-SPS in a manner similar to that discussed above with respect to MT-SDT session 520. The SDT transmission(s), using the DL-SPS resources, may be in the subsequent transmission phase or as the first DL transmission in response to the initial uplink transmission.

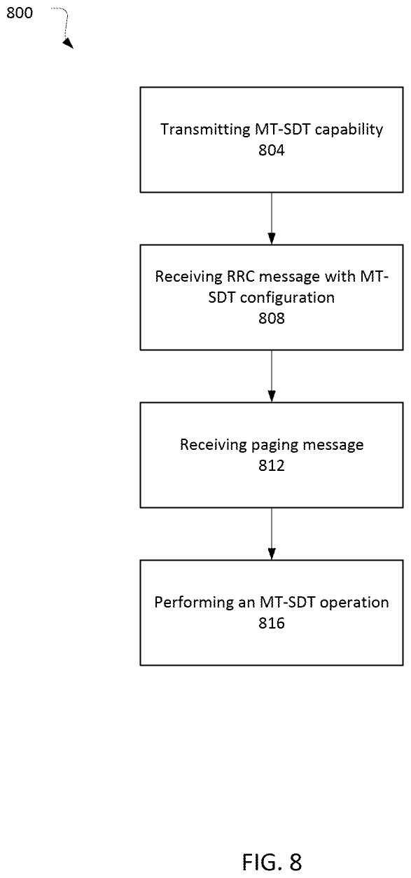

FIG. 8 illustrates an operation flow/algorithmic structure 800 in accordance with some embodiments. The operation flow/algorithmic structure 800 may be performed by a UE such as, for example, UE 104 or 1000, or components thereof, for example, processing circuitry 1004.

The operation flow/algorithmic structure 800 may include, at 804, transmitting an MT-SDT capability. The MT-SDT capability may be transmitted to the base station of a RAN. The MT-SDT capability may be included within an AS capability IE and may indicate whether the UE is capable of performing MT-SDT. In some embodiments, if the UE is capable of performing MT-SDT, the MT-SDT capability may provide further details of the supported procedures or features of MT-SDT operation. The MT-SDT capability may be per UE, frequency band, frequency range, or duplexing scheme.

The operation flow/algorithmic structure 800 may further include, at 808, receiving an RRC message with an MT-SDT configuration. The MT-SDT configuration may configure the UE for MT-SDT operation in accordance with the UE's MT-SDT capabilities. The configuration information may further include information on the resources that are to be used for SDT transmissions. These SDT transmissions may include the MT-SDT transmissions, feedback transmissions, and MO-SDT transmissions. The RRC message may be an RRC release message transmitted to instruct the UE to transition from an RRC connected state to an RRC inactive state.

The operation flow/algorithmic structure 800 may further include, at 812, receiving a paging message. The paging message may be received from the network to inform the UE that downlink SDT data is available at the network. In some embodiments, the UE may transmit a feedback message to acknowledge successful receipt of the paging message.

The operation flow/algorithmic structure 800 may further include, at 816, performing an MT-SDT operation. The MT-SDT operation may be one or more of the operations associated with a first or second MT-SDT procedure as shown and discussed with respect to FIGS. 2 and 5, respectively. These operations may include transmitting/receiving SDT data (and possibly, feedback) in an MO-SDT session (such as MO-SDT session 216) or an MT-SDT session (such as MT-SDT session 520).

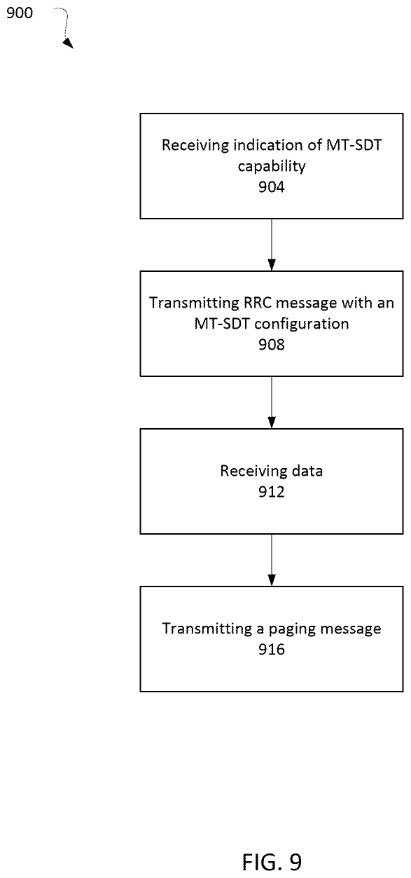

FIG. 9 illustrates an operation flow/algorithmic structure 900 in accordance with some embodiments. The operation flow/algorithmic structure 900 may be performed by a base station such as, for example, base station 112 or 1100, or components thereof, for example, processing circuitry 1104.

The operation flow/algorithmic structure 900 may include, at 904, receiving an indication of an MT-SDT capability of a UE. The MT-SDT capability may be similar to that described elsewhere herein.

The operation flow/algorithmic structure 900 may further include, at 908, transmitting an RRC message with an MT-SDT configuration. The MT-SDT configuration may configure the UE for MT-SDT operation in accordance with the UE's MT-SDT capabilities. The configuration information may further include information on the resources that are to be used for SDT transmissions. These SDT transmissions may include the MT-SDT transmissions, feedback transmissions, and MO-SDT transmissions. The RRC message may be an RRC release message transmitted to instruct the UE to transition from an RRC connected state to an RRC inactive state.

The operation flow/algorithmic structure 900 may further include, at 912, receiving data. The data may be received from a core network for transmission to the UE. The base station may analyze the data to determine whether it is more efficient to transmit the data as an MT-SDT transmission to the UE while the UE is in an inactive state or to transition the UE to a connected state and transmit the data as a regular downlink transmission.

In this embodiment, the base station may determine that the data is to be transmitted as an MT-SDT transmission and the operation flow/algorithmic structure 900 may further include, at 916, transmitting the paging message. The paging message may indicate to the UE that the network has data to transmit in an MT-SDT transmission. After the paging message is transmitted, the base station may engage in MT-SDT operations associated with a first or second MT-SDT procedure as shown and discussed with respect to FIGS. 2 and 5, respectively. These operations may include transmitting/receiving SDT data (and possibly, feedback) in an MO-SDT session (such as MO-SDT session 216) or an MT-SDT session (such as MT-SDT session 520).

FIG. 10 illustrates a UE 1000 in accordance with some embodiments. The UE 1000 may be similar to and substantially interchangeable with UE 104 of FIG. 1.

The UE 1000 may be any mobile or non-mobile computing device, such as, for example, mobile phones, computers, tablets, XR devices, glasses, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1000 may include processors 1004, RF interface circuitry 1008, memory/storage 1012, user interface 1016, sensors 1020, driver circuitry 1022, power management integrated circuit (PMIC) 1024, antenna structure 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack 1036 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1012 may include one or more computer-readable media that includes instructions (for example, communication protocol stack 1036) that may be executed by one or more of the processors 1004 to cause the UE 1000 to perform various operations described herein. The memory/storage 1012 include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands including bands in FR1 or FR2.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various I/O devices that may be present within, or connected to, the UE 1000. For example, the driver circuitry 1012 may include circuitry to facilitate coupling of a UICC (for example, UICC 148) to the UE 1000. For additional examples, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000 including DRX as discussed herein.

A battery 1028 may power the UE 1000, although in some examples the UE 1000 may be mounted deployed in a fixed location, and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

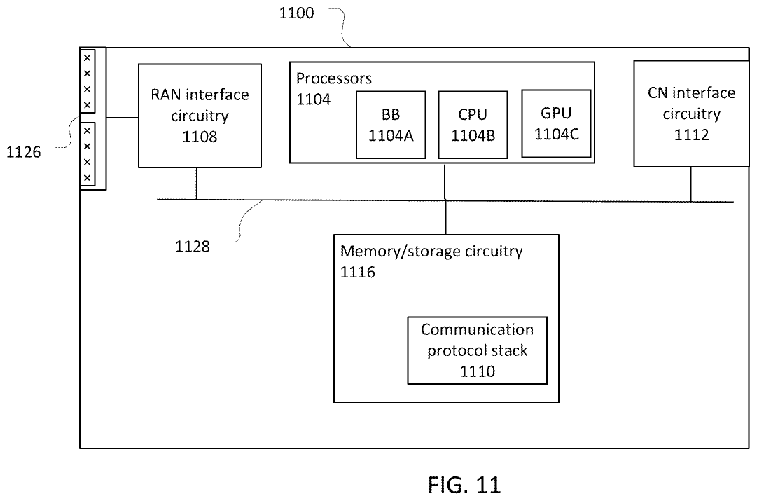

FIG. 11 illustrates a network node 1100 in accordance with some embodiments. The network node 1100 may be similar to and substantially interchangeable with base station 112, serving BS 304, or anchor BS 308.

The network node 1100 may include processors 1104, RF interface circuitry 1108 (if implemented as an access node), core network (CN) interface circuitry 1112, memory/storage circuitry 1116, and antenna structure 1126.

The components of the network node 1100 may be coupled with various other components over one or more interconnects 1128.

The processors 1104, RF interface circuitry 1108, memory/storage circuitry 1116 (including communication protocol stack 1110), antenna structure 1126, and interconnects 1128 may be similar to like-named elements shown and described with respect to FIG. 10.

The CN interface circuitry 1112 may provide connectivity to a core network, for example, a 5th Generation Core network (5GC) using a 5GC-compatible network interface protocol such as carrier Ethernet protocols, or some other suitable protocol. Network connectivity may be provided to/from the network node 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

In some embodiments, the network node 1100 may be coupled with transmit receive points (TRPs) using the antenna structure 1126, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a user equipment (UE), the method comprising: transmitting, to a network, an indication of a mobile terminated (MT)-small data transmission (SDT) capability; receiving, from the network, a radio resource control (RRC) message that includes an MT-SDT configuration; receiving, from the network, a paging message to indicate a presence of downlink data for the UE; and performing an MT-SDT operation based on the paging message and the MT-SDT configuration.

Example 2 includes a method of example 1 or some other example herein, further comprising: generating an access stratum (AS) capability information element (IE) to include the MT-SDT capability; and transmitting the AS capability IE to the network.

Example 3 includes method of example 1 or some other example herein, wherein the MT-SDT capability indicates the UE is capable of performing a first MT-SDT procedure that includes a mobile originated (MO)-SDT transmission or is capable of performing a second MT-SDT procedure that does not include an MO-SDT transmission.

Example 4 includes a method of example 1 or some other example herein, wherein the MT-SDT capability indicates whether the UE supports one or more downlink (DL)-semi-persistent scheduling (SPS) configurations in an MT-SDT procedure.

Example 5 includes a method of example 1 or some other example herein, wherein the MT-SDT capability is per UE, band, frequency range, or duplexing scheme.

Example 6 includes a method of example 1 or some other example herein, wherein performing the MT-SDT operation comprises: transmitting, based on the paging message, a mobile-originated (MO)-SDT transmission; and receiving an MT-SDT transmission after transmitting the MO-SDT transmission.

Example 7 includes a method of example 6 or some other example herein, wherein the MO-SDT transmission is a random access transmission.

Example 8 includes method of example 6 or some other example herein, wherein the RRC message includes an indication of a configured grant resource, and the MO-SDT transmission is a configured grant transmission that uses the configured grant resource.

Example 9 includes the method of example 6 or some other example herein, wherein the RRC message further includes an MO-SDT configuration.

Example 10 includes a method of operating a user equipment (UE), the method comprising: receiving, from a network, a radio resource control (RRC) message that includes a mobile-terminated (MT)-small data transmission (SDT) configuration; receiving, from the network, a paging message to indicate a presence of downlink data for the UE; and monitoring a physical downlink control channel (PDCCH) during an MT-SDT session, wherein the MT-SDT session begins a period of time after receipt of the paging message.

Example 11 includes the method of example 10 or some other example herein, further comprising: transmitting a feedback message to indicate a successful receipt of the paging message.

Example 12 includes the method of example 11 or some other example herein, further comprising: receiving, in the RRC message, information to configure physical uplink control channel (PUCCH) or sounding reference signal (SRS) resources; and transmitting the feedback message as a PUCCH or SRS transmission using the PUCCH or SRS resources.

Example 13 includes the method of example 12 or some other example herein, further comprising: selecting a downlink beam; and selecting the PUCCH or SRS resources based on an association between the downlink beam and the PUCCH or SRS resources.

Example 14 includes the method of example 11 or some other example herein, further comprising: generating a media access control (MAC) control element (CE); and transmitting the MAC CE as the paging message using a physical uplink shared channel (PUSCH) resource.

Example 15 includes a method of example 10 or some other example herein, further comprising: determining a cell-radio network temporary identity (C-RNTI) based on the RRC message or an inactive-radio network temporary identity (I-RNTI); and monitoring the PDCCH based on the C-RNTI.

Example 16 includes the method of example 10 or some other example herein, further comprising: starting an SDT timer when the UE begins monitoring of the PDCCH; and terminating the monitoring of the PDCCH based on an expiration of the SDT timer.

Example 17 includes the method of example 10 or some other example herein, further comprising: receiving, in the RRC message, configuration information to provide a semi-persistent scheduling (SPS) configuration; determining an SPS occasion based on the SPS configuration; and monitoring the PDCCH in the SPS occasion.

Example 18 includes a method of example 17 or some other example herein, wherein the configuration information is to configure a plurality of SPS configurations and the method further comprises: receiving, in the paging message, activation information to activate the SPS configuration from the plurality of SPS configurations.

Example 19 includes a method of operating a base station, the method comprising: receiving, from a user equipment (UE), an indication of a mobile terminated (MT)-small data transmission (SDT) capability; transmitting, to the UE, a radio resource control (RRC) message that includes an MT-SDT configuration; receiving data to be transmitted to the UE; and transmitting, to the UE, a paging message to indicate presence of the data to be transmitted to the UE in an MT-SDT transmission.

Example 20 includes the method of example 19 or some other example herein, further comprising: receiving, a mobile originated (MO)-SDT transmission from the UE; and transmitting the MT-SDT transmission to the UE based on the MO-SDT transmission.

Example 21 includes the method of example 20 or some other example herein, wherein the MO-SDT transmission is a random-access transmission or a configured grant transmission.

Example 22 includes the method of example 19 or some other example herein, wherein the base station is an anchor base station and the method further comprises: receiving, from a serving base station, a context fetch request; and transmitting the data to the serving base station based on the context fetch request.

Example 23 includes the method of example 22 or some other example herein, wherein the context fetch request includes an MT-SDT indication and transmitting the data to the serving base station is further based on the MT-SDT indication.

Example 24 may include an apparatus comprising means to perform one or more elements of a method described in or related to any of examples 1-23, or any other method or process described herein.

Example 25 may include one or more computer-readable media comprising instructions to cause an electronic device, upon execution of the instructions by one or more processors of the electronic device, to perform one or more elements of a method described in or related to any of examples 1-23, or any other method or process described herein.

Example 26 may include an apparatus comprising logic, modules, or circuitry to perform one or more elements of a method described in or related to any of examples 1-23, or any other method or process described herein.

Example 27 may include a method, technique, or process as described in or related to any of examples 1-23, or portions or parts thereof.

Example 28 may include an apparatus comprising: one or more processors and one or more computer-readable media comprising instructions that, when executed by the one or more processors, cause the one or more processors to perform the method, techniques, or process as described in or related to any of examples 1-23, or portions thereof.

Example 29 may include a signal as described in or related to any of examples 1-23, or portions or parts thereof.

Example 30 may include a datagram, information element, packet, frame, segment, PDU, or message as described in or related to any of examples 1-23, or portions or parts thereof, or otherwise described in the present disclosure.

Example 31 may include a signal encoded with data as described in or related to any of examples 1-23, or portions or parts thereof, or otherwise described in the present disclosure.

Example 32 may include a signal encoded with a datagram, IE, packet, frame, segment, PDU, or message as described in or related to any of examples 1-23, or portions or parts thereof, or otherwise described in the present disclosure.

Example 33 may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Example 34 may include a computer program comprising instructions, wherein execution of the program by a processing element is to cause the processing element to carry out the method, techniques, or process as described in or related to any of examples 1-23, or portions thereof.

Example 35 may include a signal in a wireless network as shown and described herein.

Example 36 may include a method of communicating in a wireless network as shown and described herein.

Example 37 may include a system for providing wireless communication as shown and described herein.

Example 38 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. One or more non-transitory, computer-readable media having instructions that, when executed, cause processing circuitry to:
output, for transmission to a network, an indication of a mobile terminated (MT)-small data transmission (SDT) capability;
receive, from the network, a radio resource control (RRC) message that includes an MT-SDT configuration;
receive, from the network, a paging message to indicate a presence of downlink data for a user equipment (UE); and
perform an MT-SDT operation based on the paging message and the MT-SDT configuration.

22. The one or more non-transitory, computer-readable media of claim 21, wherein the instructions, when executed, further cause the processing circuitry to:
generate an access stratum (AS) capability information element (IE) to include the MT-SDT capability; and
output the AS capability IE for transmission to the network.

23. The one or more non-transitory, computer-readable media of claim 21, wherein the MT-SDT capability indicates the UE is capable of performing a first MT-SDT procedure that includes a mobile originated (MO)-SDT transmission or is capable of performing a second MT-SDT procedure that does not include an MO-SDT transmission.

24. The one or more non-transitory, computer-readable media of claim 21, wherein the MT-SDT capability indicates whether the UE supports one or more downlink (DL)-semi-persistent scheduling (SPS) configurations in an MT-SDT procedure.

25. The one or more non-transitory, computer-readable media of claim 21, wherein the MT-SDT capability is per UE, band, frequency range, or duplexing scheme.

26. The one or more non-transitory, computer-readable media of claim 21, wherein to perform the MT-SDT operation the processing circuitry is to:
generate, based on the paging message, a mobile-originated (MO)-SDT transmission; and
receive an MT-SDT transmission after transmitting the MO-SDT transmission.

27. The one or more non-transitory, computer-readable media of claim 26, wherein the MO-SDT transmission is a random access transmission.

28. The one or more non-transitory, computer-readable media of claim 26, wherein the RRC message includes an indication of a configured grant resource, and the MO-SDT transmission is a configured grant transmission that uses the configured grant resource.

29. The one or more non-transitory, computer-readable media of claim 26, wherein the RRC message further includes an MO-SDT configuration.

30. An apparatus comprising:
processing circuitry to:
receive, from a network, a radio resource control (RRC) message that includes a mobile-terminated (MT)-small data transmission (SDT) configuration;
receive, from the network via the RF circuitry, a paging message to indicate a presence of downlink data for a user equipment (UE); and
monitor a physical downlink control channel (PDCCH) during an MT-SDT session, wherein the MT-SDT session begins a period of time after receipt of the paging message; and
interface circuitry coupled with the processing circuitry to enable communication.

31. The apparatus of claim 30, wherein the processing circuitry is further to:
generate, for transmission, a feedback message to indicate a successful receipt of the paging message.

32. The apparatus of claim 31, wherein the processing circuitry is further to:
receive, in the RRC message, information to configure physical uplink control channel (PUCCH) or sounding reference signal (SRS) resources; and
generate the feedback message as a PUCCH or SRS transmission using the PUCCH or SRS resources.

33. The apparatus of claim 32, wherein the processing circuitry is further to:
select a downlink beam; and
select the PUCCH or SRS resources based on an association between the downlink beam and the PUCCH or SRS resources.

34. The apparatus of claim 31, wherein the processing circuitry is further to:
generate a media access control (MAC) control element (CE); and
output the MAC CE as the paging message using a physical uplink shared channel (PUSCH) resource.

35. The apparatus of claim 30, wherein the processing circuitry is further to:
determine a cell-radio network temporary identity (C-RNTI) based on the RRC message or an inactive-radio network temporary identity (I-RNTI); and
monitor the PDCCH based on the C-RNTI.

36. The apparatus of claim 30, wherein the processing circuitry is further to:
start an SDT timer when the UE begins monitoring of the PDCCH; and
terminate the monitoring of the PDCCH based on an expiration of the SDT timer.

37. The apparatus of claim 30, wherein the processing circuitry is further to:
receive, in the RRC message, configuration information to provide a semi-persistent scheduling (SPS) configuration;
determine an SPS occasion based on the SPS configuration; and
monitor the PDCCH in the SPS occasion.

38. The apparatus of claim 37, wherein the configuration information is to configure a plurality of SPS configurations and the processing circuitry is further to:
receive, in the paging message, activation information to activate the SPS configuration from the plurality of SPS configurations.

39. A method comprising:
receiving, from a user equipment (UE), an indication of a mobile terminated (MT)-small data transmission (SDT) capability;
generating, for transmission to the UE, a radio resource control (RRC) message that includes an MT-SDT configuration;
receiving data to be transmitted to the UE; and
generating, for transmission to the UE, a paging message to indicate presence of the data to be transmitted to the UE in an MT-SDT transmission.

40. The method of claim 39, further comprising:
receiving a mobile originated (MO)-SDT transmission from the UE; and
generating the MT-SDT transmission based on the MO-SDT transmission.
